(19) United States
(12) Patent Application Publication
(10) Pub. No.: US 2010/0046057 A1
(43) Pub. Date: Feb. 25, 2010

(54) Micro electronic mechanical system oscillating laser scanning unit

(76) Inventors: San-Woei Shyu, Taipei (TW); Jau-Jan Deng, Taipei (TW); Ming-Hua Wen, Taipei (TW)

Correspondence Address: Muncy, Geissler, Olds & Lowe, PLLC, P.O. BOX 1364, FAIRFAX, VA, 22038-1364, US

(21) Appl. No.: 11/980,799

(22) Filed: Oct. 31, 2007

(51) Int. Cl. G02B 26/10

(52) U.S. Cl. 359/206.1; 359/207.11

(57) ABSTRACT

A MEMS oscillating laser scanning unit (LSU) composed of a MEMS Control Module, a Pre-scan Module and a Post-scan Module is disclosed. The MEMS Control Module consists of a laser source and a MEMS oscillating mirror. The laser source and the MEMS oscillating mirror both are aligned with the same side, opposite to target surface so that laser beam emits from the side of the target surface, reverses by a reflection mirror of the Pre-scan Module and then moves along a plane formed by a central axis as well as an oscillatory rotary axis of the MEMS oscillating mirror, enters center of the MEMS oscillatory mirror. Thus, scanning spots on the target surface are all symmetrical to the central axis. Thus effective area of the MEMS oscillating mirror is reduced and further reduce the cost as well as improve scanning efficiency. Moreover, design of the fθ Lens is simpler and the volume of the LSU is reduced.

### BACKGROUND OF THE INVENTION

The present invention relates to a Micro Electronic Mechanical System (MEMS) oscillating laser scanning unit (LSU), and more particularly, to a laser scanning unit that optically scans laser light and projects to target object drum used in a laser printer, a scanner, and a multi-function printer (MFP) using the same.

Most of LSU available now uses a polygonal mirror rotating at high speed to control reflection direction of laser beam. However, due to working rotational speed limits, high manufacturing cost, high noises and crawling start-up, such LSU is unable to meet requirements of high speed and high precision.

In recent years, torsion oscillators are getting known yet are not progressively applied to LSU of an imaging system, a scanner, a laser printer or a multi-function printer (MFP). The main cause is they still have some problems such as resonant frequency instability. However, the MEMS (micro electronic mechanic system) oscillatory mirror developed based on principle of torsion oscillators has higher scanning efficiency than conventional polygon mirror. Due to advantages of compact, light, rugged and fast resonance frequency, it is expected that the polygon mirror is going to be replaced by MEMS oscillating mirror in near future.

Refer to FIG. 1 & FIG. 2, in a laser scanning unit (LSU) a Micro Electronic Mechanical System (MEMS) oscillating mirror mainly includes circuit board, torsion oscillators and reflection mirror. The reflection mirror driven by resonance magnetic field oscillates along X-axis with Y-axis as axis of symmetry. When a laser beam emits to the reflection mirror surface of the MEMS oscillating mirror, the MEMS oscillating mirror reflects the incident laser beam toward the Z-axis at different angles along with different rotating angles of the mirror surface that changes with time. Thus features, of high resolution and large rotation angle are achieved. Therefore, it has been applied broadly such as in U.S. Pat. No. 5,408,352, U.S. Pat. No. 5,867,297, U.S. Pat. No. 6,947,189, U.S. Pat. No. 7,190,499, TW Patent M253133 and JP 2006-201350.

There are two placements for laser beam incident to the polygon mirror or the MEMS oscillating mirror, respectively having its shortcomings:

(1) laser light is obliquely incident to the polygon mirror or the MEMS oscillating mirror, as shown from FIG. 1 to FIG. 4:

Refer to Taiwanese Patent No. M253133, U.S. Pat. No. 7,184,187, U.S. Pat. No. 7,190,499, U.S. Pat. No. 6,956,597 and US Pub. App. No. 2006/0050346, in the devices disclosed, the laser beam is obliquely focused onto the polygon mirror or the MEMS oscillating mirror. In the US Pub. App. No. 2006/0033021, the laser beam is reflected by a reflection mirror and then is obliquely incident to the MEMS oscillating mirror (or polygon mirror). There are two concerns that result in deviation of the reflected laser beam. The first concern is assembly tolerance between laser source and MEMS oscillating mirror (or polygon mirror) that leads to the inconsistence incident angle. Furthermore, after scanning through the polygon mirror or the MEMS oscillating mirror, deviation of the scanning beam is generated. The prior techniques to deal with this are to calibrate the emitting angle of light with the laser source by a plurality times of precise alignment. That's waste time and money. The second concern is the relationship between the scanning angle and time. After being reflected by the polygon mirror, the relationship between the scanning angle of the laser beam and time is linear. However, after being reflected by the MEMS oscillating mirror, the relationship between the scanning angle and time is intrinsic non-linear. Refer from FIG. 1 to FIG. 4, the laser beam P1 reflected by a reflection mirror of a Pre-scan Module and then is obliquely incident to the MEMS oscillating mirror P2 for reflective scanning. Then the scanning beam P3 enters the fθ or f-sin θ lens P4 and projects onto a target surface P5 for performing scanning. Because incident angle of the scanning beam P3 on right and left sides of a central axis P6 are different while entering the fθ or f-sin θ lens P4, this is called deviation of the Y axis, as shown in FIG. 4, θ₁≠θ₂. The prior techniques way to eliminate the deviation is by means of various curved surfaces that form optical surfaces on the right and left sides. A linear fθ lens is designed and is manufactured for compensation, as disclosed in U.S. Pat. No. 6,330,524 or TW Patent No. I250781. Yet there is still problems of skew or bow generated. Refer to U.S. Pat. No. 6,232,991, the prior art is tried to solve the bow. However, both difficulties in manufacturing of the lens and cost are increased.

(2) laser light is frontal incident to the polygon mirror or the MEMS oscillating mirror:

Refer to JP Patent No. 08-334716, JP Patent No. 2006-276133, U.S. Pat. No. 6,690,498, and US Pub. App. No. 2.007/0002446, the laser light through the reflection mirror is frontal incident to the polygon mirror. But the polygon mirror, generally is hexagonal mirror, is disposed on outer edge of the rotary axis. Once the laser light is frontal incident to the polygon mirror, the distance between each point on the mirror and the rotary axis is unequal so that reflective point of the laser beam is not the same point. This causes deviation of the Y axis. Moreover, refer to US2006/0279826, although the laser light is directly focused into the MEMS oscillating mirror. Because the MEMS oscillating mirror is a prism, the laser beam with a Gaussian distribution projects into top of the oscillatory prism and is reflected into two light beams. Due to displacement of the top of the prism, the reflected light beam is with new Gaussian distribution. And the reflective point as well as size of the reflected light beam changes along with movement of the reflection mirror.

Offset in Y axis will lead to asymmetry of spots to the central axis of the MEMS oscillating mirror. Thus cause different resolution on the right and left sides of the scanning image. A fθ or f-sin θ lens may be used to form different optical surface for right and left sides for compensation. However, there are still problems of skew or bow, as mentioned in U.S. Pat. No. 6,232,991. As to light spot deviation, it is unable to be compensated by means of optical surface formed by the fθ lens.

In addition, the LSU applied to color printers or scanners requires four sets of scanning optical elements for displaying four colors-black, magenta, yellow and cyan. For example, a device disclosed in US 2006/027982 includes two sets of laser sources and two sets of MEMS oscillating mirror. Refer to Taiwanese Patent No. I268867, the device revealed consists of four sets of laser sources and four sets of MEMS oscillating mirror. Due to high cost of MEMS oscillating mirror, there is a need to develop a colorful laser scanner with only one MEMS oscillating mirror.

### SUMMARY OF THE INVENTION

Therefore it is a primary object of the present invention to provide a MEMS oscillating laser scanning unit consisting of a MEMS Control Module, a Pre-scan Module, a Post-scan Module and a housing. The MEMS Control Module is composed of a laser source, and a MEMS oscillating mirror. The laser source as well as the MEMS oscillating mirror are arranged on the same side, opposite to target surface so that laser beam incidents in reverse direction by a reflection mirror of a Pre-scan Module, along a plane formed by a central axis and an oscillatory rotary axis of the MEMS oscillating mirror, enters center of the MEMS oscillatory mirror. Then the reflected laser beam enters fθ Lens set inside the said Post-scan Module in a scanning way symmetrical to the central axis of the MEMS oscillating mirror, and size of the spots of laser beam is symmetrical to the axis of the MEMS oscillating mirror. Thus design of the fθ lens set may be simplified and the volume of the device may be reduced.

### BRIEF DESCRIPTION OF THE DRAWINGS

FIG. 1 is a schematic drawing showing top view of an MEMS oscillating LSU of a prior art;

FIG. 2 is a perspective view of another MEMS oscillating LSU of a prior, art;

FIG. 3 is a perspective view of a further MEMS oscillating LSU of a prior art;

FIG. 4 is a schematic drawing showing asymmetrical laser beam formed by the MEMS oscillating mirror in FIG. 3;

FIG. 5 is a schematic drawing showing a side view of an embodiment (single color) according to the present invention;

FIG. 6 is a schematic drawing showing upper part of a top view of the embodiment in FIG. 5;

FIG. 7 is a schematic drawing showing lower part of a top view of the embodiment in FIG. 5;

FIG. 8 is a perspective view of the embodiment in FIG. 5;

FIG. 9 is a perspective view showing the laser beam in the embodiment in FIG. 5 is projected directly into the MEMS oscillating mirror;

FIG. 10 is a perspective view showing a symmetrical laser beam formed by the MEMS oscillating mirror of the embodiment in FIG. 5;

FIG. 11 is a schematic view showing a side view of a reflection cylinder lens in the embodiment (single color) in FIG. 5;

FIG. 12 is a schematic view showing a side view of another embodiment (multiple color) according to the present invention.

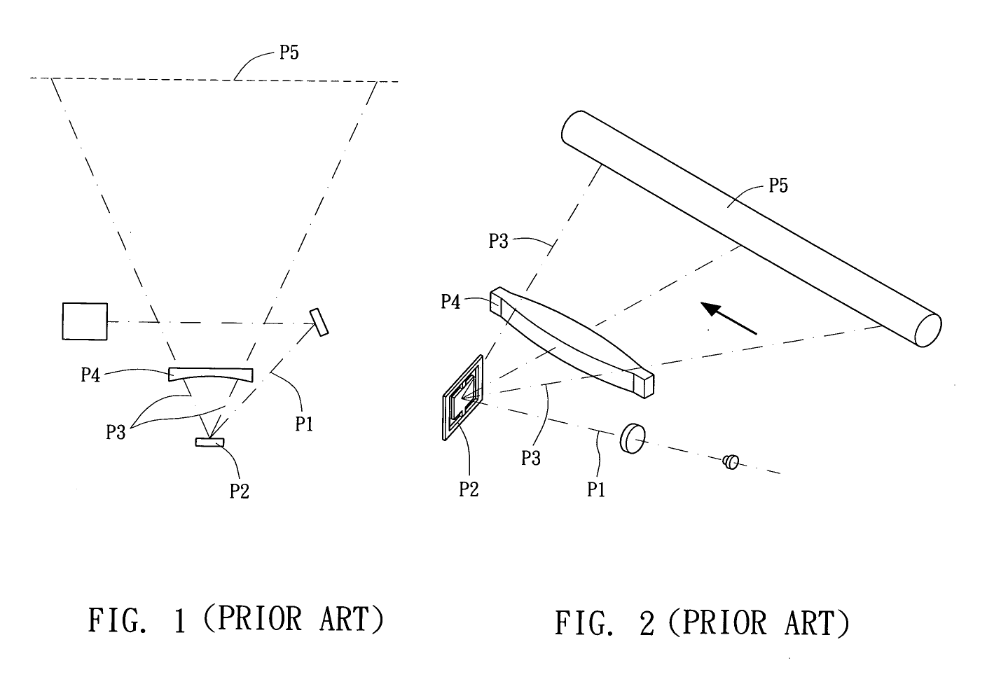

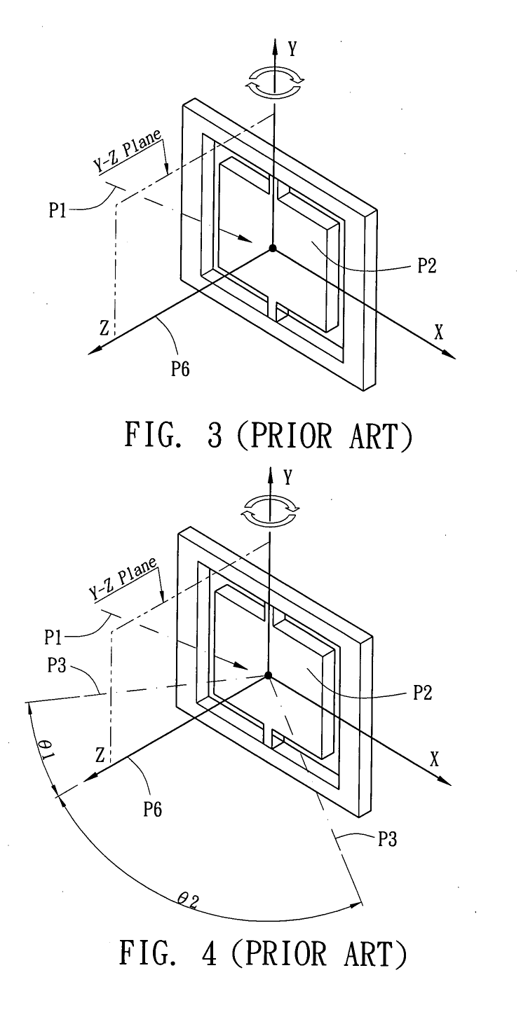

### DETAILED DESCRIPTION OF THE PREFERRED EMBODIMENT

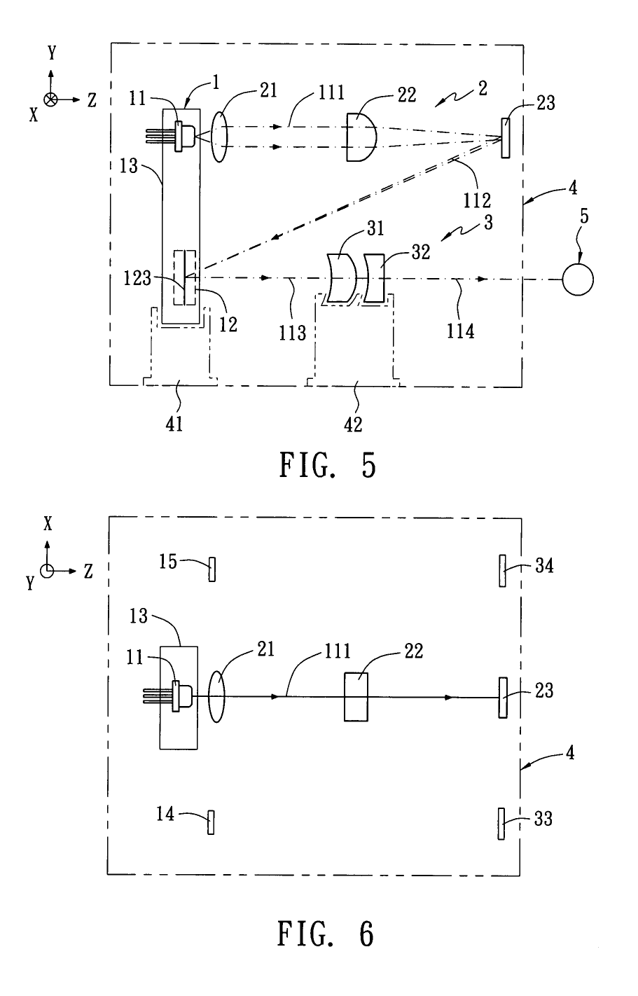

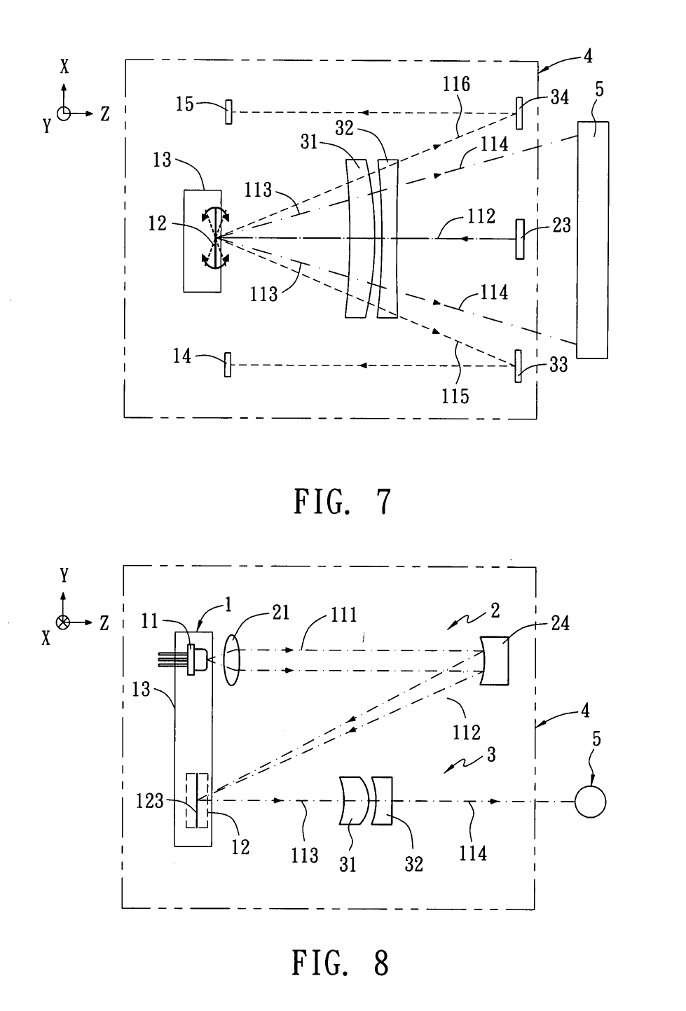

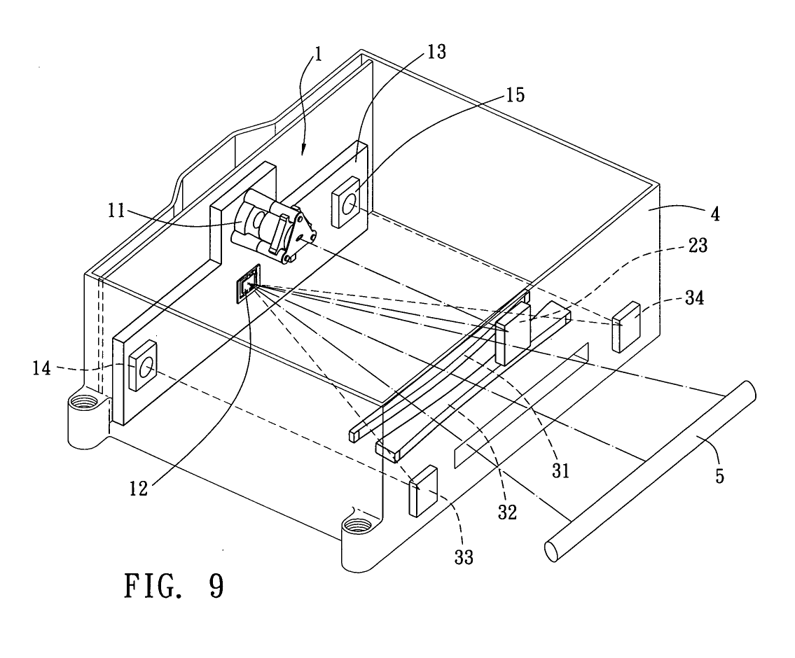

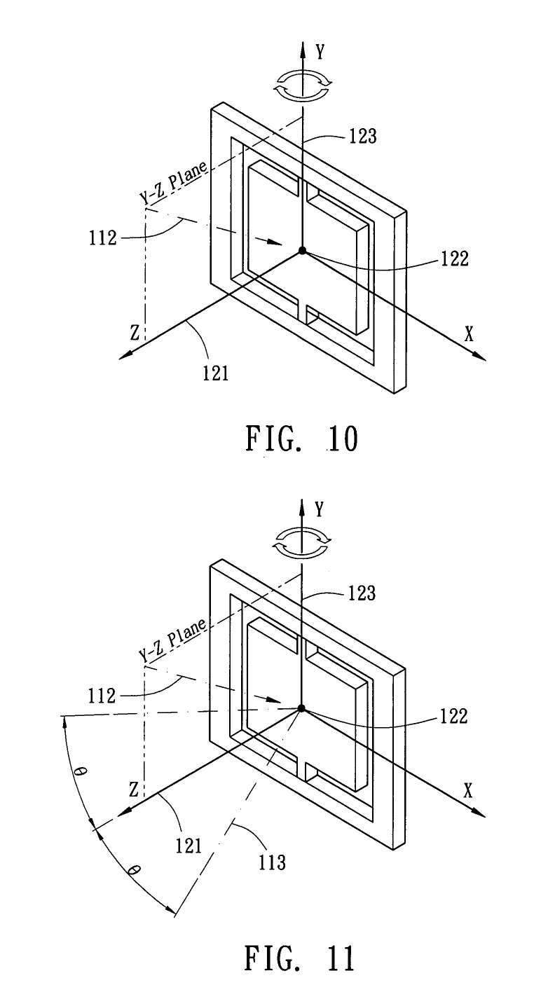

Refer from FIG. 5 to FIG. 10, a MEMS oscillating LSU according to the present invention comprises of a MEMS control module 1, a Pre-scan Module 2, a Post-scan Module 3, and a housing 4. The MEMS control module 1 comprises of a laser source 11, a MEMS oscillating mirror 12, a sensor 14 and a control board (printed circuit board) 13 while the Pre-scan Module 2 comprises a collimator lens 21, a cylinder lens 22, and a reflection mirror 23. The present invention is characterized in that: the laser source 11 and the MEMS oscillating mirror 12 are disposed on the same side, opposite to a target surface 5 so that laser light 111 emitted from the laser source 11 passes the collimator lens 21 to form parallel light beam, through the cylinder lens 22 for being focused, and then being projected onto the reflection mirror 23, as shown in FIG. 5 & FIG. 6. Next, direction of the laser light 111 is reversed by the reflection mirror 23 so as to form a laser beam 112. The laser beam 112 incidents along a plane (Y-Z plane) formed by a central axis 121 (Z axis) of the MEMS oscillating mirror 12 and an oscillatory rotary axis 123 (Y axis) of the MEMS oscillating mirror, enters and focus onto the center 122 of the MEMS oscillatory mirror 12. After being scanned, the laser beam 112 becomes into a scanning beam 113 that enters into a fθ Lens 31 (32) of the a Post-scan Module 3, as shown in FIG. 5 & FIG. 7.

Refer to FIG. 5, FIG. 6 & FIG. 7, the reversed direction means the axis of the laser beam 112 from the reflection mirror 23 to the center 122 of the MEMS oscillatory mirror 12; and the axis of the laser light 111 from the laser source 11, through the collimator lens 21 or the cylinder lens 22 to the reflection mirror 23 are located on the same Y-Z plane, without x-axis deviation.

The Post-scan Module comprises fθ Lens 31 (32) and a Synchronizing Mirror (34). The fθ Lens 31 (32) is used to covert the Scanning Beam formed by the MEMS oscillating mirror 12 into an Imaging Beam 114 in which the scanning angle and time are converted linearly. The image is formed on a target surface 5. An Synchronizing mirror 33 (34) is for reflecting the Synchronizing scanning beam 115/116 out of image range of the target surface 5 back to the MEMS Control Module 1, as shown in FIG. 7. The sensor 14 (15) turns the reflected light beam into electrical signal that is processed and transmitted by the MEMS Control Module 1. Moreover, the fθ Lens 31 (32) can be designed into a single piece type, a plurality piece type having a first fθ lens 31 and a second fθ lens 32, as shown in the figure. Similarly, the Synchronizing mirror 33 (34) can be a single piece type, a plurality piece type having a first Synchronizing mirror 33 and a second Synchronizing mirror 34, as shown in the FIG. 6 & FIG. 7. The number of the sensor 14 (15) is corresponding to the number of the Synchronizing mirror 33 (34). The sensor 14 (15) can be a single one, two sensors, corresponding to the first sensor 14 and the second sensor 15, and is disposed on the MEMS Control Module 1. The housing 4 is used to accommodate of all components, locate the components and isolate the components for maintaining their positions and precision.

The relationship between clear aperture D of the MEMS oscillating mirror and beam size of incident laser light d is as following:

$$D = \frac{d}{sin ( Φ )} , \qquad ( I )$$

Wherein, Φ is the angle between the laser beam 112 and the MEMS oscillating mirror 12;

Hence, this invention, the laser beam 112 is vertically projected to the MEMS oscillating mirror 12 so that is the angle Φ is close to 90 degrees is and D is close to d. Thus the reflective surface of the MEMS oscillating mirror 12 can be quite small size to elevate the reliability. On the other hand, once the laser light is obliquely incident into the MEMS oscillating mirror 12, the angle Φ is less than 90 degrees and the clear aperture D of the MEMS oscillating mirror 12 is larger than d. Thus the reflective surface of the MEMS oscillating mirror 12 can't be diminished size.

The present invention has at least following advantages:

(1) As shown in FIG. 11, asymmetry problem arises when the laser beam 111 is obliquely incident to the MEMS oscillating mirror 12 realized as enlarged spots or difficulty in optical design; instead of this invention, the laser beam 111 is frontal incident to the MEMS oscillating mirror 12 leading in symmetry along the z axis.
(2) The clear aperture (D) of the MEMS oscillating mirror 12 is smaller than the effective diameter (D) of the design of obliquely incident to the MEMS oscillating mirror. Thus manufacturing cost of the MEMS oscillating mirror 12 is reduced. Moreover, the scanning frequency is also accelerated due to reduction of the reflection surface and elevated the reliability.
(3) Because the laser source 11, the MEMS oscillating mirror 12 and the sensor 14 (15) are all arranged on the same side so that they can be assembled on one Control board 13 to form an integrated MEMS Control Module 1. Therefore, manufacturing, assembling, calibrating and maintenance operation can be simplified and the cost is reduced more effectively.

Standard assembling and aligning procedures of the MEMS oscillating LSU with a MEMS Control Module 1 composed of a laser source 11, a MEMS oscillating mirror 12, a control board 13 and a sensor 14 include following steps:

assembling in alignment of the laser source 11, the MEMS oscillating mirror 12, the control board 13 and the sensor 14 (15) according to designed angles and positions; and then adjust the laser source 11 as well as the collimator lens 21 by optical instruments for calibration to form a calibrated module;
calibrating the collimator lens 21 and the cylinder lens 22 for aligning with the reflection mirror 23;
adjusting reflection angle of the reflection mirror 23 so as to make the laser light incident in reverse direction and then to perform calibration so as to make the laser beam incidents along a plane (Y-Z plane) defined by a central axis 121 (Z-axis) of the MEMS oscillating mirror 12 and an oscillatory rotary axis 123 (Y-axis) of the MEMS oscillating mirror 12 and enters a center 122 of the MEMS oscillating mirror 12;
then adjusting the central axis of the fθ Lens 31 (such as the first fθ Lens 31 and the second fθ Lens 32) for aligning with a central axis of the MEMS oscillating mirror 12 and adjust an axial surface of the fθ Lens 31 for aligning with reflective surface of the MEMS oscillating mirror 12;
at last, adjusting the Synchronizing mirror 33 (34) and the sensor 14 (15) for aligning with each other so that the laser light is reflected to the sensor 14 (15) on the Control board 13.

The assembling method as mentioned above has at least following advantages:

(1) The complicated and repeated calibration of conventional assembling way is avoided so that both assembling and calibration (alignment) are more convenient and fast.
(2) The alignment of the MEMS Control Module 1 with the collimator lens 21 is not affected by volume of the LSU so that the module can be calibrated in advance before being assembled. Thus assembling of the LSU is more fast and convenient.
(3). As to colorful LSU, laser lights emitted from a plurality of sets of laser sources (as shown in FIGS. 11, 11a˜11d) are reversed and are projected to the MEMS oscillating mirror 12. Thus it takes only one MEMS oscillating mirror 12 to scanning the four colors. The four colors MEMS Control Module 1 can be calibrated before assembled. Therefore, cost of optical elements is reduced dramatically.

Refer to FIG. 8, said the cylinder lens 22 and said the reflection mirror 23 can be integrated in designed a reflection cylinder lens 24. One side of the reflection cylinder lens 24 is concave cylindrical lens while the other side is coated with reflective film so that it has both reflecting and focusing functions. While being assembled, the reflection cylinder lens 24 is aligned so as to make the laser beam 112 move along the plane (Y-Z plane) defined by the central axis (Z-axis) 121 of the MEMS oscillating mirror 12 and the oscillatory rotary axis (Y-axis) 123 of the MEMS oscillating mirror 12 and enters the center 122 of the MEMS oscillating mirror 12. Because the reflection cylinder lens 24 has functions of the cylinder lens 22 as well as the reflection mirror 23 so that it can effectively shorten light path with fewer optical elements. Thus not only volume of the LSU is correspondingly reduced but also cost is saved.

The position for disposition of the MEMS oscillating mirror 12 is located on the same side of the laser source 11 (the X-Y plane), same placement of Z-axis. The MEMS oscillating mirror 12 and the laser source 11 can be arranged on the same control board 13 or respectively arranged on the same side of different Control board 13.

While designing the LSU, the position and angle of each optical element arranged inside the housing 4 are determined according to the optical path. That means according to calculation results of the optical path, slots 41 or pedestals 42 of the optical elements are preset inside the housing 4, as shown in FIG. 5. Thus each optical element is mounted on each slot 41 or the pedestal 42 so that they can be assembled quickly and located remaining within tolerance.

The MEMS oscillating mirror 12 oscillates on resonant frequency that is easy to be affected by temperature. Thus heat generated by the fθ lens 31 inside the MEMS oscillating LSU of the present invention should be released. The pedestal 42 of the fθ lens 31 in the housing 4 is made by metal with high heat dissipation efficiency such as aluminum and is connected with a base of the metal housing 4 so that heat generated by the fθ lens 31 is conducted through the aluminum pedestal 42 to the housing 4 for dissipation.

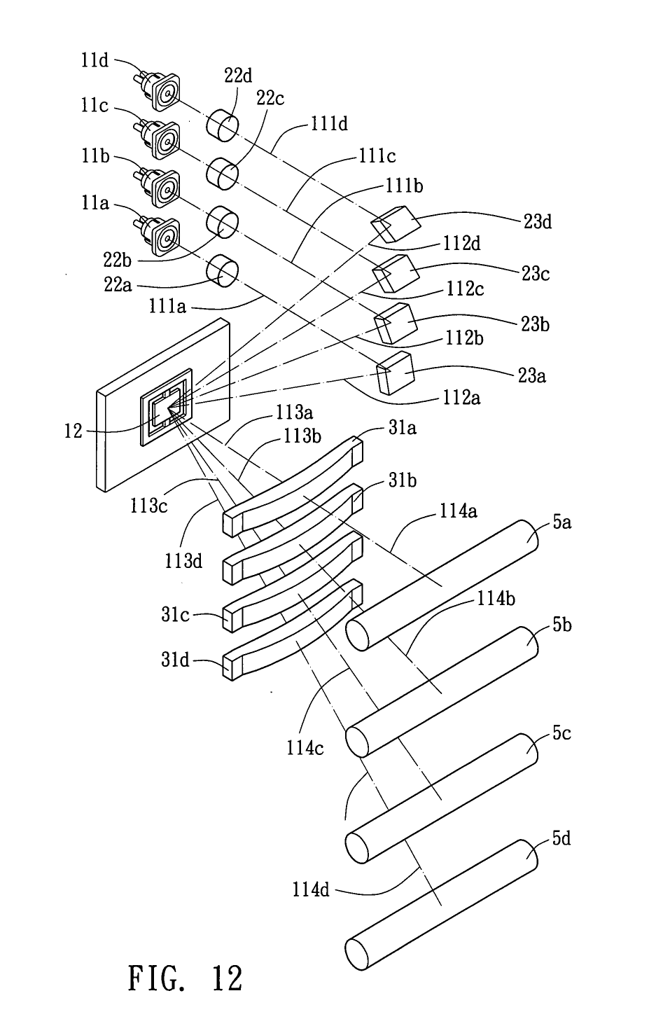

Refer to FIG. 12, a MEMS oscillating LSU of the present invention applied to color laser printers or scanners includes a precision housing 4 for accommodating the MEMS Control Module 1, a Pre-scan Module 2, a Post-scan Module 3, and other elements. The MEMS Control Module 1 is composed of a Control board 13, laser sources 11a˜11d and a MEMS oscillating mirror 12. The Pre-scan Module 2 is composed of a plurality of collimator lenses 21, a plurality of cylinder lenses 22, and a plurality of reflection mirrors 23; the Post-scan Module 3 is composed of a plurality of fθ lenses 31a˜31d. The laser sources 11a˜11d and the MEMS oscillating mirror 12 are disposed on the same side, opposite to target surfaces 5a˜5d, and are respectively above or below the MEMS oscillating mirror 12.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A Micro Electronic Mechanical System (MEMS) oscillating laser scanning unit (LSU) comprising a MEMS Control Module, a Pre-scan Module, and a Post-scan Module, wherein
the said MEMS control module disposed on opposite side of a target surface, comprising one or plurality of laser source, a MEMS oscillating mirror and a control board; wherein, the laser source emitting laser beam incident to the said Pre-scan Module;
the MEMS oscillating mirror reflecting the incident laser beam into the Post-scan Module by oscillation;
the said control board generating and receiving electronic signals for control of the laser source as well as the MEMS oscillating mirror;
the said Pre-scan Module comprising one or plurality of reflection mirror that reversing direction of incident laser beam from the laser source and incident along a plane formed by the central axis of the MEMS oscillating mirror and the oscillatory rotary axis of the MEMS oscillating mirror to the center of the MEMS oscillatory mirror;
and the said Post-scan Module comprising one or plurality of fθ lens corresponding to the laser beam reflected by the MEMS oscillating mirror so that the reflected laser beam is incident to the said fθ lens and then is projected to the target surface for constant linear scanning.

2. The MEMS oscillating LSU according to claim 1, wherein the Pre-scan Module further comprising one or plurality of collimator lens and one or plurality of cylinder lens.

3. The MEMS oscillating LSU according to claim 1, wherein the Pre-scan Module further comprising one or plurality of collimator lens and one or plurality of cylinder lens; wherein, the collimator receiving laser beam from the laser source to form parallel beam that is incident to the cylinder lens.

4. The MEMS oscillating LSU according to claim 1, wherein the fθ lens of the Post-scan Module is a single piece fθ lens or a plurality of fθ lens.

5. The MEMS oscillating LSU according to claim 1, wherein the MEMS control module further comprising one or plurality of sensor, and the Post-scan Module comprising one or plurality of Synchronizing Mirror corresponding to the sensor;
the sensor is disposed on the same side with the laser source, the MEMS oscillating mirror and the control board; and the Synchronizing Mirror is disposed on rear side of the fθ lens.

6. The MEMS oscillating LSU according to claim 1, wherein the MEMS oscillating LSU further comprising a housing that is disposed with slots or pedestals of optical elements of the MEMS control module, the Pre-scan Module and the Post-scan Module for accommodation of each optical element.

7. The MEMS oscillating LSU according to claim 6, wherein part of or the whole housing is made from metal and the pedestals or the slot of the fθ lens is made by conductive metal or material so as to conduct heat generated by the fθ lens through the pedestals or the slot to metal part of the housing for heat transferring.
